(19) United States
(12) Patent Application Publication
(10) Pub. No.: US 2019/0330712 A1
(43) Pub. Date: Oct. 31, 2019

(54) METHOD FOR SEPARATING METAL BY SOLVENT EXTRACTION SYNERGIZED COMPLEXATION

(71) Applicant: Chaoyang University of Technology, Taichung City (TW)

(72) Inventor: Wen-Yu WANG, New Taipei City (TW)

(21) Appl. No.: 16/235,792

(22) Filed: Dec. 28, 2018

(30) Foreign Application Priority Data
Apr. 30, 2018 (TW) 107114674

(51) Int. Cl. C22B 3/00

(52) U.S. Cl. CPC C22B 23/0461; B01D 11/0492; C22B 23/0484

(57) ABSTRACT

A method for separating metal by solvent extraction synergized complexation is provided. The method includes: extracting an aqueous phase metal complex with an oil phase extractant; obtaining an extracted oil phase and a raffinate aqueous phase; stripping the extracted oil phase to obtain a first metal solution; and precipitating or electrolyzing the first metal solution to recover a first metal. Wherein, the aqueous phase metal complex includes a first metal complex and a second metal complex. The first metal complex includes a first metal ion and a first ligand ion. The second metal complex includes a second metal ion and a second ligand ion. The first metal ion differs from the second metal ion. Wherein, the oil phase extractant includes at least one of a diluent and an auxiliary agent and the oil phase extractant is saponified by a saponification agent before or in the extracting step.

### CROSS-REFERENCE TO RELATED APPLICATION

This application claims priority from Taiwan Patent Application No. 107114674, filed on Apr. 30, 2018, in Taiwan Intellectual Property Office, the disclosures of which are hereby incorporated by reference in their entirety.

### BACKGROUND OF THE INVENTION

### 1. Field of the Invention

This application is a method for separating metal, in particular to a method for separating metal by solvent extraction synergized complexation.

### 2. Description of the Related Art

Taking a broad view of the world, cobalt (Co) and nickel (Ni) are some of the raw materials for secondary lithium batteries. Therefore, with the increasing use of secondary lithium batteries, the use of the amount of cobalt and nickel has been increasing year by year along with their prices. Furthermore, cobalt and nickel are also required for some special alloy materials, dyes, electroplating products, and so on used in daily life. Although cobalt is widely distributed in the earth crust, the content thereof only constitutes 0.0023%. Up to 98% of cobalt metal is a by-product collected from copper ore and nickel ore, resulting in low purity of the obtained cobalt metal. This makes cobalt metal become the premier candidate for conflict minerals after gold, tantalum, tungsten, and tin. In the meantime, both cobalt and nickel are transition metals arranged adjacent to each other on the periodic table of elements, meaning that the physicochemical properties of the two are similar, leading to the difficulty in separating and recovering cobalt and nickel.

The conventional separating and recovering technologies of cobalt and nickel mainly include the chemical precipitation method, the solvent extraction method, the flotation method, the double aqueous phase extraction method, the ion-exchange resin method, the polymer-salt-water liquid-solid extraction (non-organic solvent liquid-solid extraction) method, the redox method, and the electric stripping method, etc.

For the conventional chemical precipitation method, cobalt contained in a ternary lithium battery may form a co-precipitated metal salt mixture. However, the low purity of the cobalt results in the value thereof being reduced to only 7.5% of the price of the high purity cobalt. For the conventional solvent extraction method, to the mixed metal such as cobalt and nickel which have a low separation factor between them, 6 to 12 stages of continuous countercurrent extraction are required to be performed to achieve a certain separation effect. Therefore, the separation factors β_{Co/Ni}, which are the ratio of the oil-aqueous phase cobalt concentrations to the oil-aqueous phase nickel concentrations, are only 67. For the conventional microemulsion separation method, an oil phase, a surfactant, an auxiliary surfactant, an alcohol, etc. are required to form a microemulsion fluid, thereby generating a separation effect. Moreover, the separation rate thereof is only slightly superior to the conventional solvent extraction method. For the method of using electro dialysis to separate mixed metal solutions having different charges after performing the complexation, the separation factor β_{Co/Ni} can be up to hundreds and the separation factor can even be infinite, which is capable of separating pure cobalt. Nevertheless, the operation time is also up to several hours. Compared with the conventional solvent extraction method which only needs a few minutes to perform separation, it is more suitable for the separation and final purification of small amount of low cobalt and high nickel solution.

Therefore, there is still a need to have a method for separating metal with fewer extraction stages and shorter extraction time to obtain high purity metal.

### SUMMARY OF THE INVENTION

In view of the aforementioned problems, the purpose of the present invention provides a method for separating metal by solvent extraction synergized complexation. This method utilizes the characteristics of differences in complex structures after the reaction of different metals with complex agents in a mixed metal solution to enhance the extraction separation factor to further solve the problems generated from the above-mentioned conventional techniques.

According to the purpose, the present invention provides a method for separating metal by solvent extraction synergized complexation, including: extracting an aqueous phase metal complex with an oil phase extractant; obtaining an extracted oil phase and a raffinate aqueous phase; stripping the extracted oil phase to obtain a first metal solution; and precipitating or electrolyzing the first metal solution to separate a first metal. Wherein, the aqueous phase metal complex includes a first metal complex and a second metal complex, the first metal complex includes a first metal ion and a first ligand ion, the second metal complex includes a second metal ion and a second ligand ion, and the first metal ion differs from the second metal ion. Wherein, the oil phase extractant includes at least one of a diluent and an auxiliary agent. The oil phase extractant is saponified by a saponification agent before or in the extracting step.

Preferably, the aqueous phase metal complex includes a negative electric metal complex, a neutral metal complex, a positive electric metal complex, or any combination thereof.

Preferably, when the aqueous phase metal complex is the negative electric metal complex, the oil phase extractant includes at least one of an acidic extractant, a neutral extractant, and an alkaline extractant.

Preferably, when the metal complex is the positive electric metal complex, the oil phase extractant includes a chelating extractant or an acidic extractant.

Preferably, the first ligand ion includes at least one of a chloride ion, a thiocyanate, and an ammonium ion.

Preferably, the molar ratio of the oil phase extractant to the first metal ion is from 1:1 to 8:1.

Preferably, when the molar ratio of the oil phase extractant to the first metal ion is from 3:1 to 5:1 when the first metal ion is a positive divalent metal ion, the first ligand ion is a negative monovalent thiocyanate ion, and the molar ratio of the first metal ion to the first ligand ion is 1:4.

Preferably, the first metal ion is one of cobalt ion, nickel ion, manganese ion, lithium ion, copper ion, iron ion, silver ion, chromium ion, cadmium ion, and zinc ion.

Preferably, the diluent includes at least one of toluene, C₃-C₂₀ naphthenes, C₆-C₂₀ alkanes, and kerosene.

Preferably, the extraction temperature is from 10° C. to 55° C.

In the present invention, the method for separating metal by solvent extraction synergized complexation has the following advantages:

(1) The present invention utilizes the difference in the extraction reaction rate between the different metal complexes, which is much larger than that in the extraction reaction rate between different metal ions, to increase the reaction rates of different metals and extractants and elevate the metal ion separation factor, thus recovering the pure metal and solving the problem of heavy metal pollution.

(2) Compared with other conventional solvent extraction techniques and traditional microemulsion extraction methods, the present invention is the only method that can operate at high concentration and large volume with the metal separation factor still being greater than 370:1. Specifically, the purity of the first-stage separation of the solvent extraction is 70% and the purity of the 6-stages separation is 95%, which is suitable for massive operation at high concentration. The purity of the first-stage separation of electro dialysis synergistic solvent extraction is 85%, which is suitable for small operation at low concentration. The purity of the first-stage separation of electro dialysis synergistic reaction extraction is 90%, which is suitable for medium operation at medium concentration. The purity of the first-stage separation of electro dialysis synergistic microemulsion extraction is 99.9%, which is suitable for small operation at low concentration. However, the purity of the first-stage separation of the method for separating metal by solvent extraction synergized complexation in the present invention is 98%, which is suitable for massive operation at high concentration. In the meantime, the separation factor of the method in the present invention is 5 times larger than that of the conventional solvent extraction method.

(3) The invention has wide applications and can be used for separation and recovery of cobalt-nickel metal in a lithium battery, recovery of waste cobalt-nickel catalyst for petroleum cracking, recovery of waste permanent magnet aluminum-cobalt-nickel magnets, recovery of waste rare earth permanent magnet cobalt-bismuth magnets, recovery of waste rare earth permanent magnet cobalt bismuth magnet, recovery of waste rare earth permanent magnet material recovery, etc.

### BRIEF DESCRIPTION OF THE DRAWINGS

FIG. 1 is a schematic flow chart of the method for separating metal by solvent extraction synergized complexation in the present invention.

FIG. 2 is a schematic diagram of the reaction of the method for separating metal by solvent extraction synergized complexation in the present invention.

FIG. 3 to FIG. 11 are analysis result diagrams of examples 1 to 9 of the method for separating metal by solvent extraction synergized complexation in the present invention.

### DESCRIPTION OF THE PREFERRED EMBODIMENTS

For the purpose of making the aforementioned purpose, technical features, and actual implementation benefits more easily understood by those skilled in prior art, the embodiments are described in more detail below with reference to the drawings.

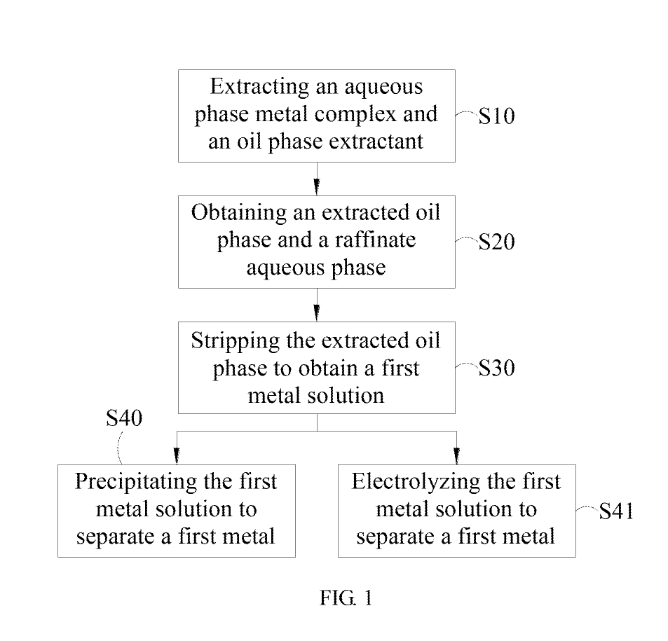

Please Refer to FIG. 1, illustrating the schematic flow chart of the method separating metal by solvent extraction synergized complexation in the present invention.

In step S10, the aqueous phase metal complex and the oil phase extractant are extracted. The aqueous phase metal complex may include a first metal complex and a second metal complex. The first metal complex may include a first metal ion and a first ligand ion. The second metal complex may include a second metal ion and a second ligand ion.

The first metal ion and the second metal ion may be identical or different. The aqueous phase metal complex may include a third metal ion different from the first metal ion and the second metal ion. The first metal ion may be the ion of cobalt, nickel, manganese, lithium, copper, iron, silver, chromium, cadmium, or zinc. The aqueous phase metal complex may be a leaching acid solution of various metals, industrial waste liquid containing metal ions, or wastewater containing metal ions. The first ligand ion and the second ligand ion may be identical or different. The first ligand ion may include at least one of a chloride ion, a thiocyanate, and an ammonium ion.

The metal complex may include a negative electric metal complex, a neutral metal complex, a positive electric metal complex, or any combination thereof. For the negative electric metal complex, a chloride ion, a thiocyanate, and so on may be used as a ligand ion. For the positive electric metal complex, an ammonium ion such as ammonia or tetraethyl ammonium, and so on may be used as a ligand ion.

When the metal complex is the negative electric metal complex, the oil phase extractant includes an acidic extractant, a neutral extractant or an alkaline extractant. Preferably, when the metal complex is a negative electric metal complex, the oil phase extractant is the acid extractant. When the metal complex is the positive electric metal complex, the oil phase extractant includes a chelating extractant or an acidic extractant. Preferably, when the metal complex is the positive electric metal complex, the oil phase extractant is the acidic extractant. Preferably, the separation factor is defined depending on the stability of the first metal complex and the second metal complex in the aqueous phase and the distribution ratio of the metal ions in the oil phase to the aqueous phase.

The acidic extractant may include, but are not limited to, carboxylic acid extractant, organophosphorus extractant, and sulfonic acid extractant. Preferably, the acidic extractant is an organic phosphate extractant. More preferably, the organic phosphate extractant may be D2EHPA (bis (2-ethylhexyl) phosphoric acid, P-204), HEHEHP (2-ethylhexylphosphonate 2-ethylhexyl ester, P-507), and Cyanex 272. The alkaline extractants may include, but are not limited to, primary amines (RNH₂) extractants, secondary amines (R₂NH) extractants, tertiary amines (R₃N) extractants, quaternary ammonium (R₄N⁺), and amide (RCONR′R″). Preferably, the alkaline extractant may be a primary amine and Alamine 336 (Tri-(C₈-C₁₀)-amine).

For example, when the ligand ion is negative electric metal complex including SCN⁻ or Cl⁻. If an acidic extractant is used, the difference in stability between the cobalt complex and the nickel complex is very beneficial for the separation of cobalt and nickel. However, when a negative electric metal complex, such as thiocyanate, and an organic amine alkaline extractant are used in a cobalt-nickel hydrometallurgical system, the extraction complex becomes too stable, which makes back extraction steps difficult to be performed and further results in the difficulty in process operation. In the meantime, excessive costs may also occur owing to the use of the organic amine alkaline extractant. Therefore, in the present invention, when the metal complex is a negative electric metal complex, an acidic extractant such as P507 or the like is used, and the number of extraction stages may be reduced from six to one. The reason may be that Co (SCN)₄²⁻ is more conducive to directly perform an ion exchange of Co (II) with Na-P507⁻.

The oil phase extractant may be adjusted according to different metal complexes. That is, the oil phase extractant may include an acidic extractant, a neutral extractant, an alkaline extractant, or any combination thereof to improve the separation effect of metal ions. Preferably, the molar ratio of the oil phase extractant to the first metal ion may be from 1:1 to 8:1.

The molar ratio of the oil phase extractant to the first metal ion is from 1:1 to 8:1 when the first metal ion is a positive divalent metal ion, the first ligand ion is a negative monovalent thiocyanate, and the molar ratio of the first metal ion to the first ligand ion is 1:4. Preferably, the molar ratio of the oil phase extractant to the first metal ion is from 3:1 to 5:1. More preferably, the molar ratio of the oil phase extractant to the normal divalent cobalt ion is from 3:1 to 9:2 when the first metal ion is a positive divalent cobalt ion, the first ligand ion is a negative monovalent thiocyanate, and the molar ratio of the positive divalent cobalt ion to the thiocyanate is 1:4.

Wherein, the oil phase extractant may include at least one of diluent and auxiliary agent. The oil phase extractant is saponified by a saponification agent before or in the extracting step.

The diluent, which does not chemically bond with the solute, is an organic solvent that dissolves the extractant and the solute thereof. It is used to reduce the concentration of the extractant to adjust the maximum extraction capacity of the extractant and the selectivity of the metal ion. When using an acid extractant such as D2EHPA, owing to the degree of polymerization of the extractant susceptible to the polarity of the diluent, the smaller the polarity of the diluent is, the more the polymerization state of the extractant will be. For example, when D2EHPA exists in a diluent with a small polarity, it will behave as a dimerization pattern (H₂A₂). Therefore, the present invention selects a diluent with a small polarity to increase the distribution ratio of the extracted metal ions. Preferably, the diluent may include at least one of toluene, C₃-C₂₀ naphthenes, C₆-C₂₀ alkanes, and kerosene. More preferably, the diluent may include heptane.

The saponification agent saponifies an extractant for modification. Since the extractant has the best range for different pH extractions for different metal ions, the saponification is modified to prevent the hydrogen ions of the extractant from being replaced by the metal ions with positive charge and released into the aqueous phase, resulting in the changes of the pH value in the aqueous phase and further leading to the problem of reducing the overall extraction efficiency. The saponification agent may be any saponification agent conventionally known to those skilled in prior art. Preferably, the saponification agent may be sodium hydroxide (NaOH).

The adjuvant may include a modifier. When the extractant chemically reacts with the metal solute to produce an extraction complex, the extraction complex usually exists in the extract phase. However, sometimes the extraction complex is neither soluble in the extract phase nor in the aqueous phase where the extraction complex is called a third phase. A modifier is added to solve the problem that the third phase is insoluble in the extract phase and the aqueous phase. The modifier may be a fatty alcohol such as n-octanol or n-nonanol.

The extraction step as mentioned above may be operated at a temperature between 10° C. and 55° C. Preferably, the extraction temperature may be from 45° C. to 55° C. If the thermal energy consumption of the operation is considered, the extraction temperature may be from 20° C. to 40° C., preferably.

In step S20, following step S10, the phase separation is performed to obtain an extracted oil phase and a raffinate aqueous phase. The phase separation step may be any phase separation step known to those skilled in prior art. The phase separation step may be realized by using a separating funnel, a centrifugal extraction tank, a centrifugal extractor, an extraction tower, a extraction column, etc.

In step S30, the extracted oil phase obtained in step S20 is stripped to obtain a first metal solution. The stripping step allows the metal in the oil phase to be returned to the aqueous phase. The stripping step may be any phase separation step known to those skilled in the art. The stripping solution may be a strong acid solution. Preferably, the stripping solution may be sulfuric acid.

In step S40 and step S41, the first metal solution obtained in step S30 is precipitated or electrolyzed to separate the first metal. Wherein, a stripping solution, an extracted oil phase, a complex agent aqueous phase, and so on may be separated to perform recycling, thereby reducing the cost of the method in the present invention.

In one embodiment, compared to conventional solvent extraction methods, the benefits of the method in the present invention for metal separation recovery are analyzed. In this embodiment, cobalt sulfate (CoSO₄.7H₂O) and nickel sulfate (NiSO4.6H₂O) are used to simulate a ternary lithium battery (LiCoO₂/LiNiO₂/LiMn₂O₄) to eliminate positive electrode material of manganese elements. That is, the first metal ion is selected as a positive divalent cobalt ion, and the second metal ion is selected as a positive divalent nickel ion. Meanwhile, the first ligand ion and the second ligand ion are both selected as a negative monovalent thiocyanate ion (SCN⁻).

First, the required sodium hydroxide of the extractant corresponding to saponification rate is calculated and dissolved into the fixed amount of the ultrapure water to obtain a sodium hydroxide solution. The phosphoric acid extractant and the diluent are mixed by a certain ratio as an oil phase extractant, and then saponified by adding a sodium hydroxide solution as a saponification agent. The oil phase extractant and the sodium hydroxide solution are added slowly by the volume ratio of 10:3, and a magnet stirrer is used to stir evenly for 30 minutes. After the phase separation, the saponification reaction is completed. The upper layer is a sodium-type extractant (NaR), which is a saponified oil phase extractant, and the lower layer is an aqueous solution of sodium salt (NaOH). The reaction process is as shown in the reaction formula (1), and the saponification ratio is calculated according to the formula (1).

Na++H̅R̅ [symbol] N̅a̅R̅+H⁺ Reaction formula (1)

Wherein, HR is a phosphoric acid extractant, the upper horizontal line indicates the oil phase, and Na⁺ is derived from sodium hydroxide.

$$\text{Saponification rate (\%)} = {m}_{HR} \times \frac{{MW}_{HR}}{{V}_{HR} \times {D}_{HR}} \qquad Formula ( 1 )$$

Wherein, m_{HR} is the number of the modified extractant mole (mol), V_{HR} is the extractant volume (mL), D_{HR} is the extractant density (g/cm³), and MW_{HR} is the extractant molecular weight (g/cm³).

Cobalt sulfate and nickel sulfate is also added to the ammonium thiocyanate (NH₄SCN) solution as an aqueous phase metal complex. The volume and the pH value of the saponified oil phase extractant and the aqueous phase metal complex are measured and poured into the separatory funnel for extraction. The extraction time is 5 minutes. The volume ratio of the oil phase extractant to the aqueous phase metal complex is 1:1. After the phase separation, the upper phase is the extracted oil phase, and the lower phase is the raffinate aqueous phase. The solutions of the two phases are respectively obtained and the changes in volume of the two are measured.

Next, a 10% sulfuric acid solution is prepared as a stripping solution. The stripping is performed by pouring the extracted oil phase and the stripping solution into the separatory funnel at a volume ratio of 1:1. The stripping time is 5 minutes. After the phase separation, the upper phase is the stripping oil phase, and the lower phase is the stripping aqueous phase. The solutions of the two phases are respectively obtained and the changes in volume of the two are measured.

The metal complex aqueous phase, the raffinate aqueous phase, and the stripping aqueous phase are analyzed. The metal concentration is measured and the metal mass is balanced according to the law of conservation of mass. The metal extraction rate (E %) is calculated and obtained according to formula (2).

$$E \% = \frac{{C}_{0} - {C}_{1}}{{C}_{0}} \times 100 \% \qquad Formula ( 2 )$$

Wherein, C₀ is the initial concentration of the extract and C₁ is the concentration of the extract after extraction.

In this embodiment, the ammonium thiocyanate complexation is adopted as shown in the reaction formula (2) and (3). Co(II) and Ni(II) are combined with SCN⁻ to form Co(SCN)₄²⁻ and Ni(SCN)₄²⁻. A cation such as a phosphoric acid extractant of P507 as shown in the reaction formula (4) is used to perform replacement to extract Co(II) into the organic phase. With the increase of the concentration of NH₄SCN, the concentration of SCN⁻ and NH₄⁺ increases, thus making the reaction formula (2) and (3) move to the right to increase the concentration of the complex. When the ratio of cobalt to thiocyanate is 1:4, a complete complexation with cobalt may occur. If the concentration of thiocyanate is insufficient, which leads to the insufficient coordination ratio, the reaction formula may tend to move to the left, thus not being able to completely form Co(SCN)₄²⁻ and further resulting in a decrease in the separation ratio of cobalt to nickel.

Co²⁺+4NH₄SCN [symbol] Co(SCN)₄²⁻+4NH₄⁺ Reaction formula (2)

Ni²⁺+4NH₄SCN [symbol] Ni(SCN)₄²⁻+4NH₄⁺ Reaction formula (3)

Co(SCN)₄²⁻+Na-P507 [symbol] Na⁺+4SCN⁻+Co-P507⁺ Reaction formula (4)

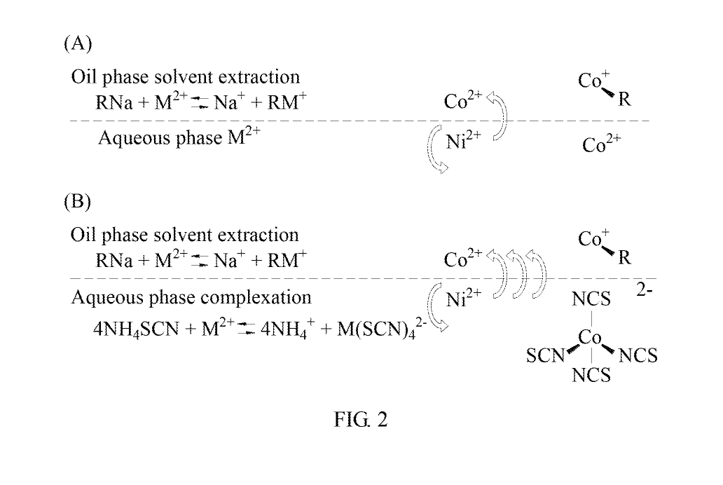

Please refer to FIG. 2, illustrating the schematic diagram of the method for separating metal by solvent extraction synergized complexation in the present invention. Part (A) of FIG. 2 shows the reaction formula for the conventional solvent extraction. Part (B) of FIG. 2 shows the reaction formula of the method for separating metal by solvent extraction synergized complexation in the present invention.

As shown in part (A) of FIG. 2, RNa is a saponified extractant and M²⁺ is a metal (such as Co²⁺, Ni²⁺). The separation ratio of Co²⁺ and Ni²⁺ is determined by the saponified extractant and Co²⁺, as well as the individual reaction rate of the saponified extractant and Ni²⁺.

As shown in part (B) of FIG. 2, originally, the aqueous phases Co²⁺ and Ni²⁺ form (H₂O)₂Co(SCN)₄²⁻ and (H₂O)₂Ni(SCN)₄²⁻ with SCN⁻ respectively. The aqueous phase is dark red. Then, the aqueous phase is mixed with the oil phase extractant (for example, P-507). Compared with nickel, the reaction rate of cobalt complex and extractant is higher. Meanwhile, the red octahedral complex of (H₂O)₂Co(SCN)₄²⁻ turns into a blue hexahedral complex of Co(SCN)₄²⁻ and enters the oil phase. This causes the aqueous phase to display a residual green complex of (H₂O)₂Ni(SCN)₄²⁻.

The following description are examples by adjusting different parameters to further analyze the benefit of the method for separating metal by solvent extraction synergized complexation in the present invention.

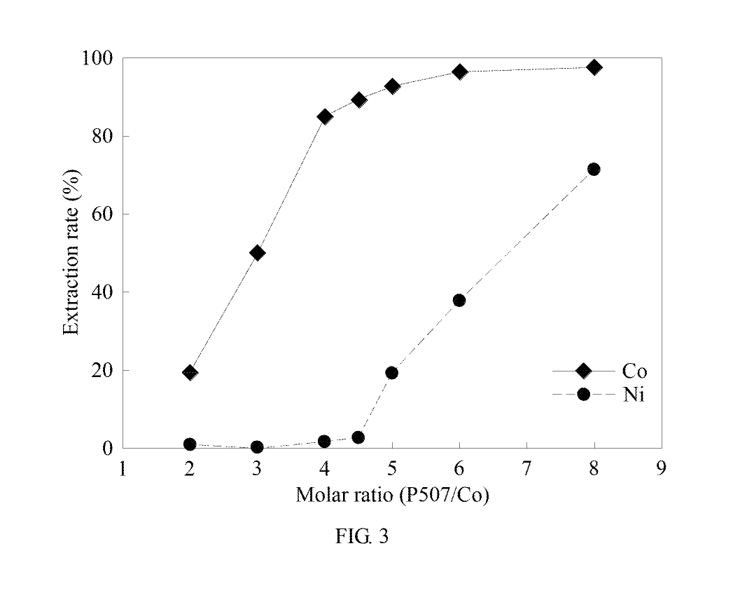

In example 1, the molar ratio of cobalt-nickel is 1:1, the number of mole for the metal is 0.015 mol, the molarity of ammonium thiocyanate is 0.7 M, the aqueous phase volume is 100 mL, and the oil-aqueous volume ratio is 1:1. The oil phase extractant has a composition of P507 and heptane with the ratio of 1:4 with sodium hydroxide solution as a saponification agent. The saponification ratio is 60% and is operated at a room temperature. The cobalt molar number is used as benchmark, and the molar ratio of the extractant to cobalt is changed to investigate the effect of different extractants on the cobalt-nickel separation. The results are shown in Table 1 and FIG. 3. FIG. 3 is the analysis result diagram of example 1 of the method for separating metal by solvent extraction synergized complexation in the present invention.

TABLE 1

| Molar | | Nickel | | | |
|---|---|---|---|---|---|
| ratio of | Cobalt | extraction | Separation | Saponif- | |
| P507 to | extraction | rate | factor | ication | Balanced |
| cobalt | rate (%) | (%) | (β_{Co/Ni}) | rate (%) | pH |
| 2 | 19.35% | 0.82% | 29.01 | 64.58% | 4.581 |
| 3 | 50.12% | 0.08% | 1297.25 | 61.77% | 4.765 |
| 4 | 85.05% | 1.50% | 373.50 | 61.09% | 4.987 |
| 4.5 | 89.22% | 2.62% | 307.79 | 62.56% | 5.241 |
| 5 | 92.71% | 19.11% | 53.81 | 61.82% | 5.683 |
| 6 | 96.34% | 37.71% | 43.50 | 61.00% | 5.677 |
| 8 | 97.61% | 71.33% | 16.39 | 61.09% | 5.926 |

Please refer to Tables 1 and FIG. 3. It is to be known that the molar ratio of P507 to cobalt increases from 2 to 4 along with a preferable effect of the cobalt-nickel extraction and separation. When the molar ratio of P507 to cobalt is 4 to 5, the extraction ratio of cobalt increases from 85.05% to 92.71% along with the increase of the molar ratio. Meanwhile, the extraction rate of nickel increases sharply from 1.50% to 19.11%. When the molar ratio is greater than 5, there is excess P507 that may still be used to extract nickel in addition to the complete extraction of cobalt. After the molar ratio of the extractant to cobalt is greater than 5, the cobalt extraction rate maintains approximately 92.72% or more, which almost achieves complete extraction. The nickel extraction rate continuously increases from 19.11% to 71.33% from the molar ratio of 5 to 8. Since 4 moles of SCN⁻ is required for the formation of Co(SCN)₄²⁻, the extractant also needs to release 4 moles of Na⁺ to replace Co(SCN)₄²⁻ during extraction, thus being able to replace Co²⁺ into the organic phase. Therefore, when the ratio of P507 to cobalt is 4 which is the optimal parameter, the extraction rate of cobalt is 85.05%, while that of nickel is only 1.50%. The highest separation factor β_{Co/Ni} is 374. However, the separation factor β_{Co/Ni} of cobalt and nickel by solvent extraction is generally only 72.

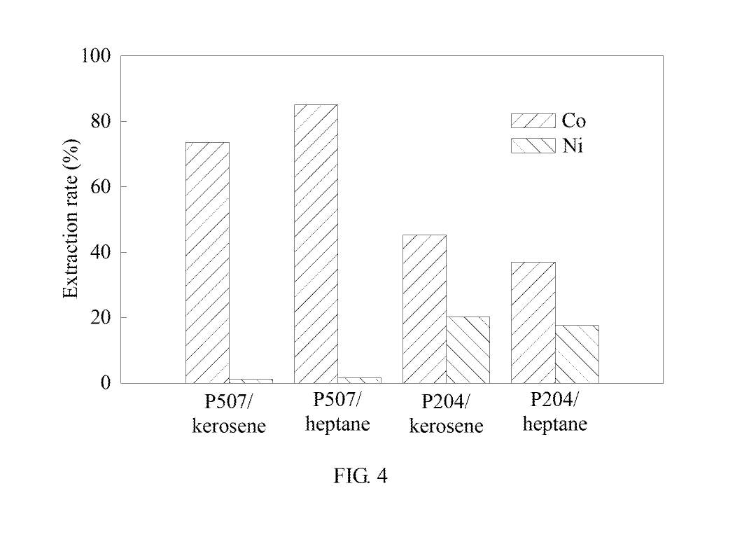

In example 2, the oil phase extractant composition is 1:4, including an extractant and a diluent. The molar ratio of the extractant to cobalt is 4. The rest conditions are the same as in example 1. A preferred combination of the extractant and the diluent is analyzed to investigate the effect of the combination of two extractants (P204, P507) and two diluents (heptane, kerosene) on the extraction of cobalt and nickel. The results are shown in Table 2 and FIG. 4. FIG. 4 is the analysis result diagram of example 2 of the method for separating metal by solvent extraction synergized complexation in the present invention.

TABLE 2

| | | Nickel | | | |
|---|---|---|---|---|---|
| Organic oil | Cobalt | extraction | Separation | Saponif- | |
| phase | extraction | rate | factor | ication | Balanced |
| composition | rate (%) | (%) | (β_{Co/Ni}) | rate (%) | pH |
| P507 and | 73.55% | 1.06% | 259.89 | 62.26% | 4.356 |
| kerosene | | | | | |
| P507 and | 85.05% | 1.50% | 373.50 | 61.09% | 4.987 |
| heptane | | | | | |
| P204 and | 45.18% | 20.13% | 3.27 | 62.74% | 4.350 |
| kerosene | | | | | |
| P204 and | 36.98% | 17.58% | 2.75 | 64.37% | 4.877 |
| heptane | | | | | |

Please refer to Table 2 and FIG. 4. It is to be known that the extraction and separation effect of the phosphoric acid extractant P507 is more significant than that of P204. The extractant P507 selects heptane as a diluent, which has a better extraction rate than that of cobalt to kerosene. Due to the complexation of cobalt ions with ammonium thiocyanate, cobalt thiocyanate is formed. The cobalt thiocyanate becomes a tetrahedral structure when extracted at the oil-aqueous interface. The thiocyanate is an octahedral structure in the solution, so the phosphoric acid extractant may firstly extracts cobalt.

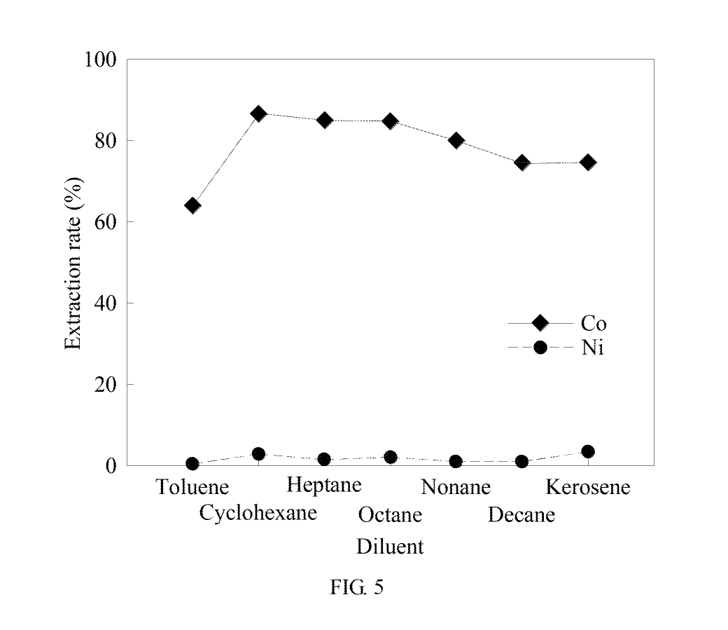

In example 3, the oil phase composition is 1:4, including P507 and a diluent. The molar ratio of P507 to cobalt is 4. The rest conditions are the same as in example 1 to analyze the effect of types of the diluent on cobalt and nickel extraction. The results are shown in Tables 3 and FIG. 5. FIG. 5 is the analysis result diagram of example 3 of the method for separating metal by solvent extraction synergized complexation in the present invention.

TABLE 3

| | Cobalt | Nickel | Separation | Saponif- | |
|---|---|---|---|---|---|
| Types of | extraction | extraction | factor | ication | Balanced |
| diluent | rate (%) | rate (%) | (β_{Co/Ni}) | rate (%) | pH |
| Toluene | 64.06% | 0.32% | 553.39 | 60.05% | 4.884 |
| Cyclohexane | 86.65% | 2.77% | 227.48 | 60.05% | 5.358 |
| Heptane | 85.05% | 1.50% | 373.50 | 61.09% | 4.987 |
| Octane | 84.79% | 2.07% | 263.44 | 60.05% | 5.060 |
| Nonane | 79.99% | 0.95% | 415.81 | 60.09% | 4.897 |
| Decane | 74.43% | 0.91% | 315.27 | 60.05% | 4.861 |
| Kerosene | 74.63% | 3.38% | 264.59 | 62.26% | 4.987 |

Please refer to Tables 3 and FIG. 5. Since toluene contains a 7C bond with high polarity, toluene has a high polarity index compared to the other diluents. This weakens the oil phase organic properties of the extractant and reduces the distribution ratio of cobalt complex in the oil-aqueous phases, thus showing the lowest cobalt extraction rate. Cyclohexane, heptane, octane, nonane, decane, and kerosene are all organic solvents with low polarity. As the length of the carbon bond increases, the viscosity increases, leading to the metal ions not to be easily ionized in the two phases. In addition, the longer the bond is, the lower the polarity will be. The acidic extractant tends to form a polymer, which is unfavorable to the reaction with metal ions. Therefore, the shortest carbon bond of heptane has the finest extraction effect.

In addition, analysis of alkanes shows that cyclohexane, heptane, octane, noncane, decane, and kerosene are all alkanes, all of which are saturated hydrocarbons, whereas toluene is an aromatic hydrocarbon. This shows that it is difficult for all the diluents to extract nickel ions. Wherein, the extraction rate of cobalt with cyclohexane, being the finest, is 86.25%, and the extraction rate of nickel is 2.77%. Therefore, it is ensured that the saturated alkane is suitable for the method in the present invention. The synergistic effect of the diluent and the extractant may affect the extraction rate due to the differences of the extracts. The best combination is the phosphoric acid extractant in combination with the saturated hydrocarbon diluent for the extraction of metal organic compounds Co and Ni. However, kerosene is primarily used in reality, which is mainly based on the determination in consideration of the recovery rate and the metal purity to economic costs. Furthermore, the polarity of the two organic solvents, namely cyclohexane and heptane, is 0, and the cobalt extraction rate is the highest. The polarity of toluene is 2.3, and the cobalt extraction rate is the lowest. Therefore, it is to be known that the increase in the polarity of the diluent may decrease the extraction capability of the extracted oil phase.

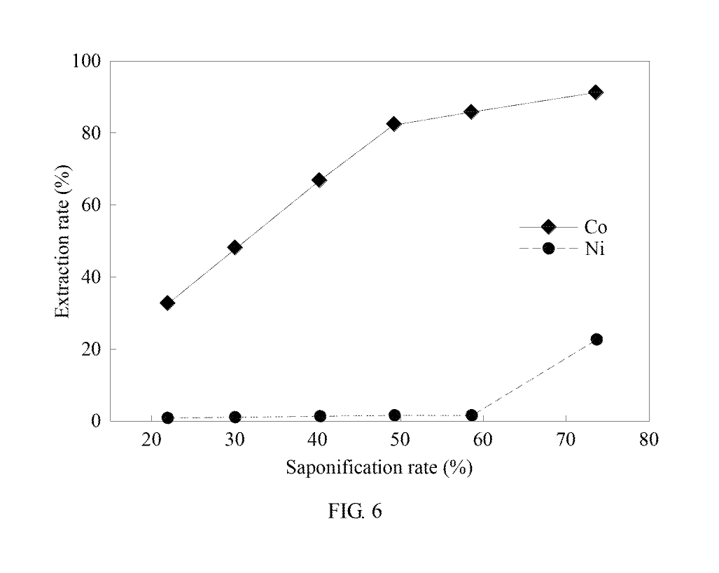

In example 4, the saponification rate is adjusted. The rest conditions are the same as in example 1 to analyze the effect of the saponification rate on the extraction of cobalt and nickel by the extractant. The results are shown in Table 4 and FIG. 6. FIG. 6 is the analysis result diagram of example 4 of the method for separating metal by solvent extraction synergized complexation in the present invention.

TABLE 4

| Saponif- | Cobalt | Nickel | Separation | |
|---|---|---|---|---|
| ication | extraction | extraction | factor | Balanced |
| rate (%) | rate (%) | rate (%) | (β_{Co/Ni}) | pH |
| 21.96% | 32.57% | 0.89% | 53.66 | 3.925 |
| 30.12% | 48.00% | 1.07% | 85.20 | 4.207 |
| 40.29% | 66.77% | 1.35% | 146.98 | 4.573 |
| 49.29% | 82.28% | 1.58% | 202.49 | 4.865 |
| 58.63% | 85.71% | 1.60% | 247.66 | 5.204 |
| 73.63% | 91.07% | 22.42% | 35.30 | 6.199 |

Please refer to Table 4 and FIG. 6. When the saponification rate is 60%, the extraction balanced pH is 5.2, which is applicable to the pH for P507 extracting cobalt ranging between 4.5 and 5.2. Therefore, when the saponification rate rises from 20% to 60%, the extraction rate of cobalt increases from 32.57% to 85.71%, and the extraction rate of nickel remains below 2%. When the saponification rate is 70%, the cobalt extraction rate is 91.07%, the nickel extraction rate increases to 22.42%, and the extraction balanced pH is 6.2. It is to be known that when the saponification rate is controlled at 60%, the finest effects may be found regarding the cobalt-nickel extraction and separation.

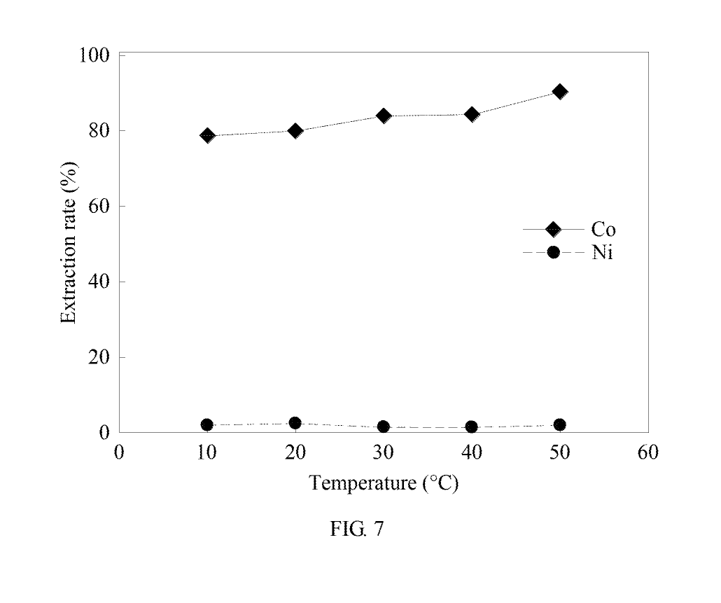

In example 5, the extraction temperature is adjusted. The rest conditions are the same as in example 1 to analyze the effect of the extraction temperature on the extraction of cobalt and nickel. The results are shown in Table 5 and FIG. 7. FIG. 7 is the analysis result diagram of example 5 of the method for separating metal by solvent extraction synergized complexation in the present invention.

TABLE 5

| | Cobalt extraction | Nickel extraction | Separation factor |
|---|---|---|---|
| Temp(° C.) | rate (%) | rate (%) | (β_{Co/Ni}) |
| 13° C. | 78.68% | 1.93% | 187.97 |
| 23° C. | 79.96% | 2.42% | 160.56 |
| 32° C. | 83.92% | 1.38% | 372.90 |
| 40° C. | 84.26% | 1.38% | 383.34 |
| 50° C. | 90.24% | 1.95% | 465.26 |

Please refer to Table 5 and FIG. 7. It is to be known that the extraction rate increases as the rise increases, meaning an endothermic reaction and suitable to be operated in a high temperature environment. When the temperature raises from a room temperature to 30° C. or up to 50° C., the cobalt extraction rate increases from 83.92% to 90.24%, and the nickel extraction rate only increases from 1.38% to 1.95%. Therefore, the optimum extraction temperature is 50° C. However, since the extraction temperature is difficult to maintain in laboratory operation, it may be operated at a room temperature.

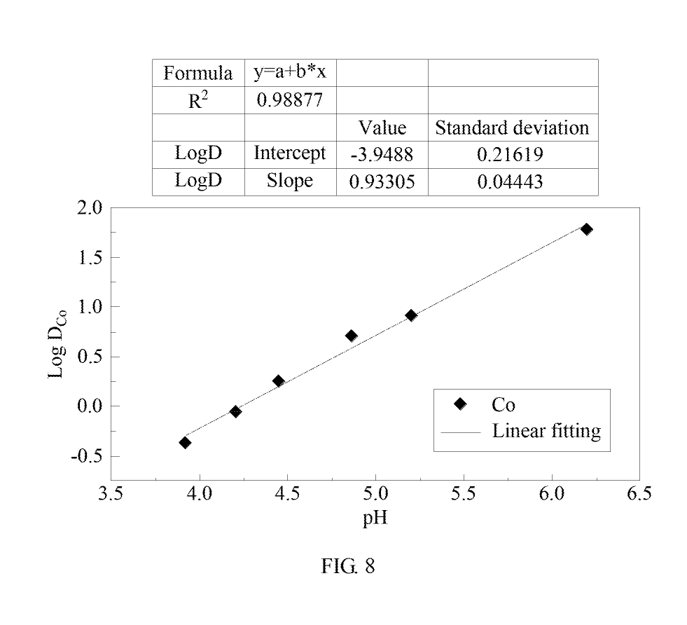

In example 1, the balanced pH is adjusted, and the rest conditions are the same as in example 1 to analyze the effect of balanced pH on the extraction of cobalt and nickel. The results are shown in Table 6 and FIG. 8. Wherein, D_{Co} is the distribution ratio of cobalt ions to the raffinate in the organic phase. FIG. 8 is the analysis result diagram of example 6 of the method for separating metal by solvent extraction synergized complexation in the present invention.

TABLE 6

| Saponification rate (%) | Balanced pH | LogD(cₒ) |
|---|---|---|
| 21.96% | 3.925 | −0.3665 |
| 30.12% | 4.207 | −0.0556 |
| 40.29% | 4.573 | 0.2504 |
| 49.29% | 4.865 | 0.7059 |
| 58.63% | 5.204 | 0.9138 |
| 73.63% | 6.199 | 1.7763 |

| | |
|---|---|
| Slope | 0.9330 |
| Intercept | −3.948 |
| Linear relation (R²) | 0.9888 |

Please refer to Table 6 and FIG. 8. Since the acid extractant is usually in a dimeric form in a diluent with a small polarity and has a slope of 0.9330, it is to be known that P507 mostly exists in a form of a monomer in heptane.

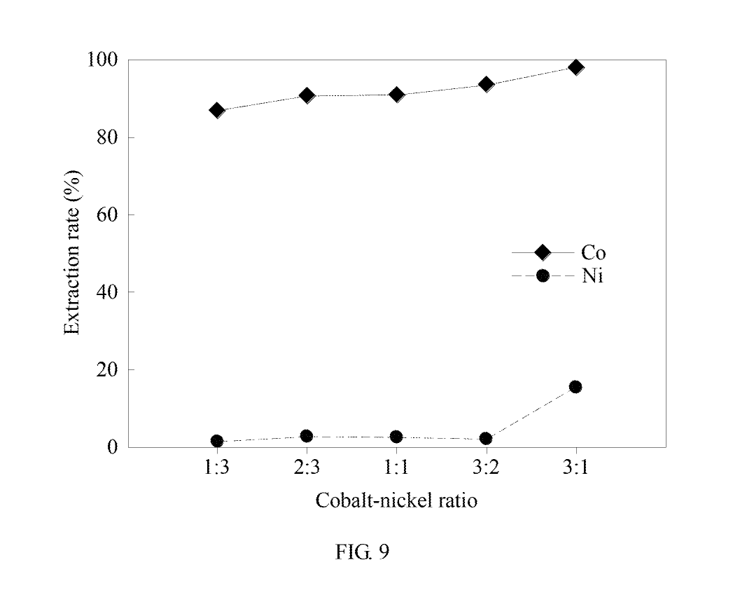

In example 7, the molar ratio of ammonium thiocyanate to nickel ion is 4.67. The volume of aqueous phase is changed by the volume of ammonium thiocyanate. The volume ratio of oil to water is changed with other parameters. The rest conditions are the same as in example 1 to analyze the effects of cobalt-nickel molar ratio on cobalt-nickel extraction. The detailed conditions are shown in Table 7, and the results are shown in Table 8 and FIG. 9. FIG. 9 is the analysis result diagram of example 7 of the method for separating metal by solvent extraction synergized complexation in the present invention.

TABLE 7

| | | | | | | Aqueous |
|---|---|---|---|---|---|---|
| Cobalt- | | | | Ammonium | Oil phase | phase |
| nickel | Cobalt | Nickel | P507 | thiocyanate | volume | volume |
| ratio | (mol) | (mol) | (mL) | (mol) | (mL) | (mL) |
| 1:3 | 0.005 | 0.015 | 6.43 | 0.070 | 32.15 | 99.43 |
| 2:3 | 0.010 | 0.015 | 12.86 | 0.070 | 64.30 | 99.43 |
| 1:1 | 0.005 | 0.005 | 19.29 | 0.024 | 32.15 | 33.14 |
| 3:2 | 0.015 | 0.010 | 19.29 | 0.047 | 96.45 | 66.28 |
| 3:1 | 0.015 | 0.005 | 6.43 | 0.024 | 96.45 | 33.14 |

TABLE 8

| Molar | | | | | |
|---|---|---|---|---|---|
| ratio of | Cobalt | Nickel | Separation | | |
| cobalt to | extraction | extraction | factor | Saponification | Balanced |
| nickel | rate (%) | rate (%) | (β_{Co/Ni}) | rate (%) | pH |
| 1:3 | 86.90% | 1.43% | 457.88 | 60.76% | 5.183 |
| 2:3 | 90.63% | 2.70% | 348.15 | 60.69% | 5.164 |
| 1:1 | 90.84% | 2.51% | 398.71 | 60.76% | 5.168 |
| 3:2 | 93.52% | 2.05% | 703.74 | 60.17% | 5.085 |
| 3:1 | 98.04% | 15.35% | 294.38 | 60.09% | 5.333 |

Please refer to Table 8 and FIG. 9. When the molar ratio of cobalt to nickel is 1:3, 2:3, 1:1, and 3:2, the cobalt extraction rate increases from 86.90% to 93.52%, and the nickel extraction rate varies from 1.43% to 2.70%. However, when the molar ratio of cobalt to nickel is 3:1, the cobalt extraction rate is 98.04% and the nickel extraction rate sharply increases to 15.35%. Since the number of moles of nickel for the raw material liquid is relatively lower than that of cobalt, the purity of the extracted recovered liquid is still more than 95%. The extraction ratio of cobalt to nickel, from 2:3 to 3:2, has the finest stability, the extraction rate of cobalt reaches 90.63%, and the extraction rate of nickel is less than 3%. Wherein, the optimal extraction ratio of cobalt to nickel is 3:2, and the highest separation factor is β_{Co/Ni} 703. In contrast, when the ratio of cobalt to nickel is 1:3, the cobalt ion is completely complexated by the thiocyanate in the aqueous phase due to the high concentration of ammonium thiocyanate, thus causing the cobalt extraction rate being slightly lowered. For the ratio of cobalt to nickel being 3:1, because the concentration of extractant is too high, there is a leakage of nickel ions extraction in the extraction process of cobalt and the extraction rate of cobalt can reach 98.04%. Nevertheless, the extraction rate of nickel also reaches 15.35% and it is confirmed that the possibility of nickel extraction may be reduced by lowering the saponification rate. Although the molar ratio of cobalt to nickel are varied with 1:3, 2:3, 1:1, and 3:2, the purities of cobalt ion in extractant phase are stable after extraction process at values of 95.30%, 95.72%, 97.3%, 98.56%, and 95.04%, respectively.

Continuously, it is to be known that the composition of the organic phase of P507 and heptane in a volume ratio is 1:4; the molar ratio of P507 to cobalt ion is 4:1; the molar ratio of ammonium thiocyanate to nickel ion is 4.67:1; the molarity of ammonium thiocyanate is 0.7 M; the oil-aqueous volume ratio is 1:1; the saponification rate is 60%; the temperature is 50° C.; the molar ratio of cobalt to nickel is 3:2; the cobalt extraction rate of 93.52%; the nickel extraction rate is only 2.05%. The above-mentioned conditions show that the method for separating metal by solvent extraction synergized complexation in the present invention has the finest effectiveness for recovering metal.

In another embodiment, the method in the present invention is proved to be effective by disassembling the waste lithium battery and recovering the mixed metal and manganese. The waste secondary lithium battery cell is disassembled. After the disassembling process, the percentage of composition to weight is 2.54% for the outer package, 5.89% for the separator, 0.34% for the metal electrode, 15.00% for the copper foil, 26.63% for the negative electrode materials, 6.40% for the aluminum foil, and 43.20% for the positive electrode materials. Aluminum is eliminated after the alkali dissolution. Meanwhile, substances other than the target metal (cobalt Co/manganese Mn/nickel Ni/lithium Li) are recovered. After eliminating aluminum, the positive electrode material is immersed in the acid solution. After the third-stage extraction, the recovery rate of Mn may reach 95%, with the leftover of the acid solution including cobalt, nickel and lithium. The following examples are done by adjusting different parameters to further analyze the benefits of the method for separating the cobalt and nickel by solvent extraction synergized complexation in the present invention. The analysis is carried out on different types of extractant, the saponification rate of extractant, the balanced pH value, the oil-aqueous phase ratio, the cobalt/nickel concentration effect, the extractant/complex agent equivalent ratio, and the extractant/metal equivalent ratio.

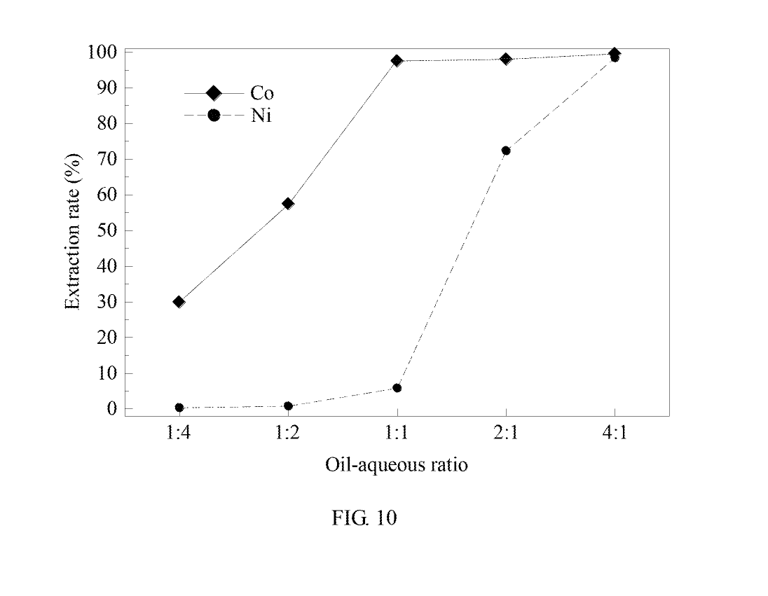

In example 8, the oil-aqueous phase ratio is adjusted, and the rest conditions are the same as in example 1 to analyze the cobalt/nickel concentration effect. The results are shown in FIG. 10.

Please refer to FIG. 10. The oil-aqueous phase volume ratio increases from 1:4 to 4:1, and the extraction amount also increases. However, the separation factor decreases.

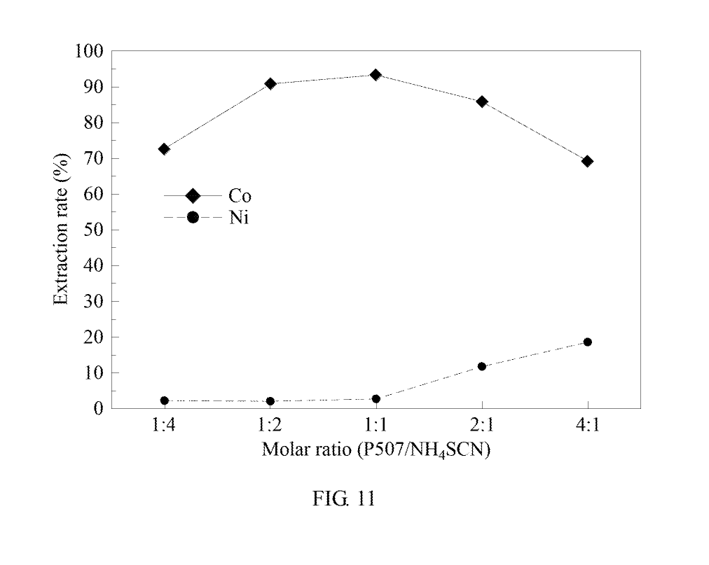

In example 9, the extractant/complex agent equivalent ratio is adjusted, and the rest conditions are the same as in example 1. The results are shown in FIG. 11.

Please refer to FIG. 11. The molar ratio of the extractant to the complex agent is 1:4, 1:2, and 1:1. The cobalt extraction rate increases from 72.59% to 93.32%, and the nickel extraction rate ranges between 2.16% to 2.67%. When the molar ratio of extractant to the complex agent is 1:1, 2:1, and 4:1, the cobalt extraction rate decreases from 93.32% to 69.21%. The nickel extraction rate increases from 2.67% to 18.55%.

Continuously, the method in the present invention is compared with the conventional solvent extraction method in terms of separation and recovery of the molar concentration ratio of cobalt to nickel as 1:1. The comparison results are shown in Table 9. Wherein, the conventional solvent extraction is operated at the Co extraction rate of 70%.

TABLE 9

| Comparison | Separation | | |
|---|---|---|---|
| for recycling | factor | Co | Co |
| techniques | (β_{Co/Ni}) | Recovery rate % | purity % |
| Conventional | 72 | First stage extraction 70 | First stage extraction 70 |
| solvent | | Six stage extraction 95 | Six stage extraction 94 |
| extraction | | | |
| Method in the | 372 | First stage extraction 85 | First stage extraction 98 |
| present | | | |
| invention | | | |

As shown in Table 9, it is to be known that the first-stage extraction cobalt recovery rate for the conventional solvent extraction is 70%. In contrast, the rate in the method in the present invention is as high as 85%. The purity of cobalt of one-stage extraction for the conventional solvent extraction is 70%. In contrast, the purity in the method in the present invention is as high as 98%. Meanwhile, the separation factor of cobalt and nickel in the method in the present invention is five times more than that of the conventional solvent extraction.

What is stated above is only illustrative examples which do not limit the present invention. Any spirit and scope without departing from the present invention as to equivalent modifications or alterations is intended to be included in the claims.

What is claimed is:

1. A method for separating metal by solvent extraction synergized complexation, comprising:
extracting an aqueous phase metal complex with an oil phase extractant;
obtaining an extracted oil phase and a raffinate aqueous phase;
stripping the extracted oil phase to obtain a first metal solution; and
precipitating or electrolyzing the first metal solution to separate a first metal;
wherein the aqueous phase metal complex comprises a first metal complex and a second metal complex, the first metal complex comprises a first metal ion and a first ligand ion, the second metal complex comprises a second metal ion and a second ligand ion, and the first metal ion differs from the second metal ion;
wherein, the oil phase extractant comprises at least one of a diluent and an auxiliary agent, and the oil phase extractant is saponified by a saponification agent before or in the extracting step.

2. The method of claim 1, wherein the aqueous phase metal complex comprises a negative electric metal complex, a neutral metal complex, a positive electric metal complex, or any combination thereof.

3. The method of claim 2, wherein when the aqueous phase metal complex is the negative electric metal complex, the oil phase extractant comprises at least one of an acidic extractant, a neutral extractant, and an alkaline extractant.

4. The method of claim 2, wherein when the metal complex is the positive electric metal complex, the oil phase extractant comprises a chelating extractant or an acid extractant.

5. The method of claim 1, wherein the first ligand ion comprises at least one of a chloride ion, a thiocyanate ion, and an ammonium ion.

6. The method of claim 1, wherein a molar ratio of the oil phase extractant to the first metal ion is from 1:1 to 8:1.

7. The method of claim 1, wherein a molar ratio of the oil phase extractant to the first metal ion is from 3:1 to 5:1 when the first metal ion is a positive divalent metal ion, the first ligand ion is a negative monovalent thiocyanate ion, and the molar ratio of the first metal ion to the first ligand ion is 1:4.

8. The method of claim 1, wherein the first metal ion is one of cobalt ion, nickel ion, manganese ion, lithium ion, copper ion, iron ion, silver ion, chromium ion, cadmium ion, and zinc ion.

9. The method of claim 1, wherein the diluent comprises at least one of toluene, C₃-C₂₀ naphthenes, C₆-C₂₀ alkanes, and kerosene.

10. The method of claim 1, wherein an extraction temperature is from 10° C. to 55° C.
